(19) United States
(12) Patent Application Publication
(10) Pub. No.: US 2005/0053899 A1
(43) Pub. Date: Mar. 10, 2005

(54) Detachable restoration tooth

(76) Inventor: Wen-Yuen Wu, Kaohsiung (TW)

Correspondence Address: BACON & THOMAS, PLLC, 625 SLATERS LANE, FOURTH FLOOR, ALEXANDRIA, VA, 22314, US

(21) Appl. No.: 10/654,990

(22) Filed: Sep. 5, 2003

(51) Int. Cl. A61C 5/08

(52) U.S. Cl. 433/218; 433/180

(57) ABSTRACT

A detachable restoration tooth has a bottom, an outer surface, and a top. The bottom is provided with a cavity to accommodate an outer crown. The restoration tooth further has two connection portions, each extending from a boundary edge of the top and the outer surface. The restoration tooth is removably mounted on the abutment seat of a restored tooth such that the outer crown is fitted over an inner crown of the abutment seat, and that the connection portions are attached to two healthy teeth adjoining the restored tooth.

### FIELD OF THE PRESENT INVENTION

The present invention relates generally to a dental treatment, and more particularly to a detachable restoration tooth.

### BACKGROUND OF THE PRESENT INVENTION

According to the general practice of dentistry, a decayed or diseased tooth is treated in such a way that the enamel of the decayed or diseased tooth is properly ground and mended, and that the enamel is restored to the original condition by means of a restoration body, which may be fixed or detachable.

As illustrated in FIGS. 1 and 2, a fixed restoration tooth “t” of the prior art is mounted on a metal crown 30 which is shaped to fit securely over a mended abutment 11 of a decayed or diseased tooth 10. The fitting of the metal crown 30 over the mended abutment 11 is attained in conjunction with a cement “C”, as shown in FIG. 2.

The abutment 11 of the decayed or diseased tooth 10 is thus restored to the original condition by the fixed restoration tooth “t”. However, the restoration tooth “t” is located between two healthy teeth “N” in such a manner that a gap “δ1” is formed between the restoration tooth “t” and each of the two healthy teeth “N”, as shown in FIG. 2. The gaps between the restoration tooth “t” and the healthy teeth “N” are apt to deposit food particles which can not be easily removed by means of ordinary oral hygiene. In addition, the deposition of the food particles in the tooth gaps is a culprit for bacterial contamination of the tooth gum.

As shown in FIGS. 3 and 4, two mended teeth 10 are provided with a detachable restoration tooth “T” of the prior art such that the restoration tooth “T” is mounted on the mended enamels 11 of the teeth 10. The mended enamels 11 are provided with a metal inner crown 20 fitted thereover. The restoration tooth “T” is provide with two outer crowns 30, which are securely fitted over the two inner crowns 20 in conjunction with a cement “C”. In spite of formation of gaps “δ1” between the restoration tooth “T” and the gum lines, the food particles deposited in the gaps can be easily removed by detaching the restoration tooth “T”. One of the two mended teeth 10 is decayed or diseased, whereas other one of the two mended teeth 10 serves as an abutment tooth. It is therefore readily apparent that the restoration tooth “T” of the prior art is formed at the expense of a healthy tooth which is used as the abutment tooth. In addition, the restoration tooth “T” is not strong enough to withstand pressure of the act of chewing.

As shown in FIGS. 5 and 6, a plurality of decayed or diseased teeth are completely extracted. Thereafter, an artificial abutment tooth 10′ is implanted to facilitate the mounting of a bridge-type restoration tooth T′ in conjunction with two healthy teeth 10 adjoining the artificial abutment tooth 10′. These two healthy teeth 10 are mended and provided with a metal inner crown 20′ which is fitted over an abutment seat 11′ thereof. The bridge-type restoration tooth T′ is provided with a plurality of outer crowns 30′ and is mounted removably on the artificial abutment tooth “10” and the two healthy teeth 10 adjoining the artificial abutment tooth 10′. In light of the restoration tooth T′ being removably mounted, the food particles deposited in the gaps “δ2” can be easily removed. Like the detachable restoration tooth “T” as shown in FIG. 4, the bridge-type restoration tooth T′ is defective in design in that an additional gap “δ4” is formed between the bridge-type restoration tooth T′ and a healthy tooth “N” adjoining the bridge-type restoration tooth T′, as shown in FIG. 6. It is conceivable that the food is apt to be caught in the gap “δ3” as shown in FIG. 4, or in the gap “δ4” as shown in FIG. 6, in the midst of the act of chewing.

### SUMMARY OF THE PRESENT INVENTION

The primary objective of the present invention is to provide a detachable restoration tooth which is provided on the top thereof with two connection portions extending therefrom. The restoration tooth is removably mounted on the abutment seat of a mended tooth such that the two connection portions are attached to the top of two healthy teeth adjoining the restoration tooth, without subjecting the two healthy teeth to being ground and mended. In another words, all healthy teeth remain intact in spite of the mounting of the restoration tooth of the present invention. In addition, the connection portions of the restoration tooth serve as a means to distribute the chewing pressure to the healthy teeth adjoining the restoration tooth, so as to alleviate the burden of the restoration tooth. As a result, the longevity of the restoration tooth of the present invention is effectively prolonged. Moreover, the connection portions of the restoration tooth of the present invention serve as a means to eliminate a gap that is formed between the top edge of the restoration tooth of the present invention and the top edge of a healthy tooth adjoining the restoration tooth. The elimination of the gap has a soothing effect on chewing.

The features and the advantages of the present invention will be more readily understood upon a thoughtful deliberation of the following detailed description of the preferred embodiments of the present invention with reference to the accompanying drawings.

### BRIEF DESCRIPTION OF THE DRAWINGS

FIG. 1 shows a sectional schematic view of a fixed restoration tooth of the prior art.

FIG. 2 shows a sectional schematic view of the prior art restoration tooth mounted fixedly on a mended tooth.

FIG. 3 shows a sectional schematic view of a detachable restoration tooth of the prior art.

FIG. 4 shows a sectional schematic view of the prior art restoration tooth mounted removably on a plurality of mended teeth.

FIG. 5 shows a sectional schematic view of a removable bridge-type restoration tooth of the prior art.

FIG. 6 shows a sectional schematic view of the prior art bridge-type restoration tooth mounted removably on a plurality of mended teeth and an artificial abutment tooth.

FIG. 7 shows a sectional schematic view of a first preferred embodiment of the present invention.

FIG. 8 shows a sectional schematic view of the first preferred embodiment of the present invention prior to the mounting thereof on a mended tooth.

FIG. 9 shows a sectional schematic view of the first preferred embodiment of the present invention mounted on the mended tooth.

FIG. 10 shows a sectional schematic view of a second preferred embodiment of the present invention.

FIG. 11 shows a sectional schematic view of the second preferred embodiment of the present invention prior to the mounting thereof on a mended tooth.

FIG. 12 shows a sectional schematic view of the second preferred embodiment of the present invention mounted on the mended tooth.

FIG. 13 shows a sectional schematic view of the second preferred embodiment of the present invention mounted on an artificial abutment tooth.

FIG. 14 shows a top view of a third preferred embodiment of the present invention mounted on a mended tooth.

FIG. 15 shows a sectional schematic view taken in the direction indicated by a line A-A as shown in FIG. 14.

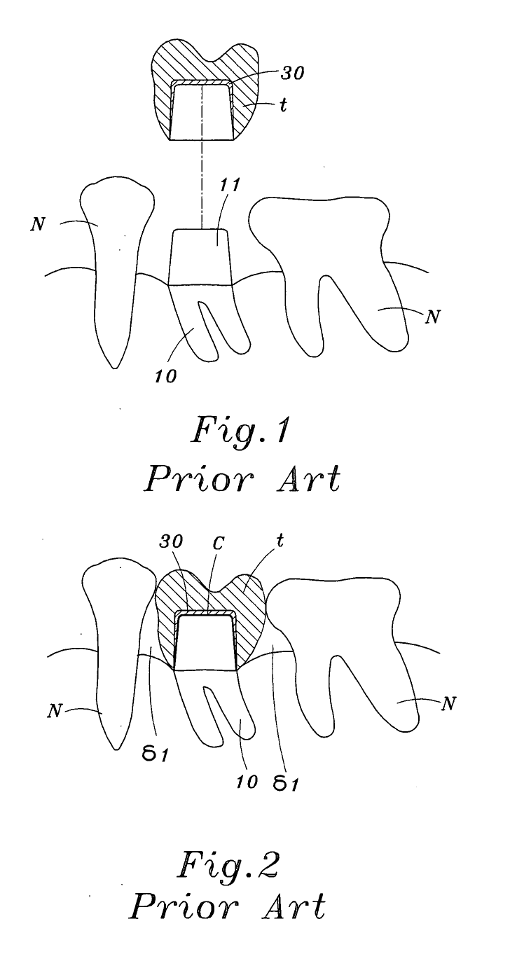

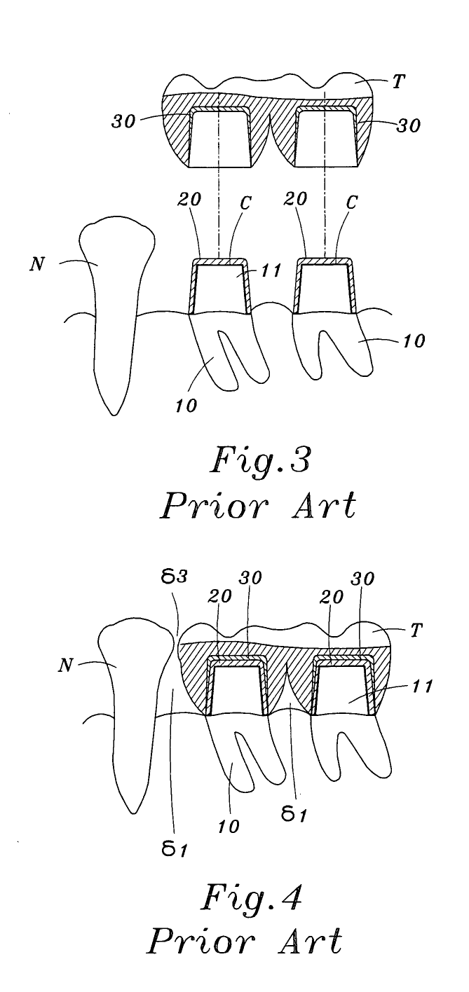

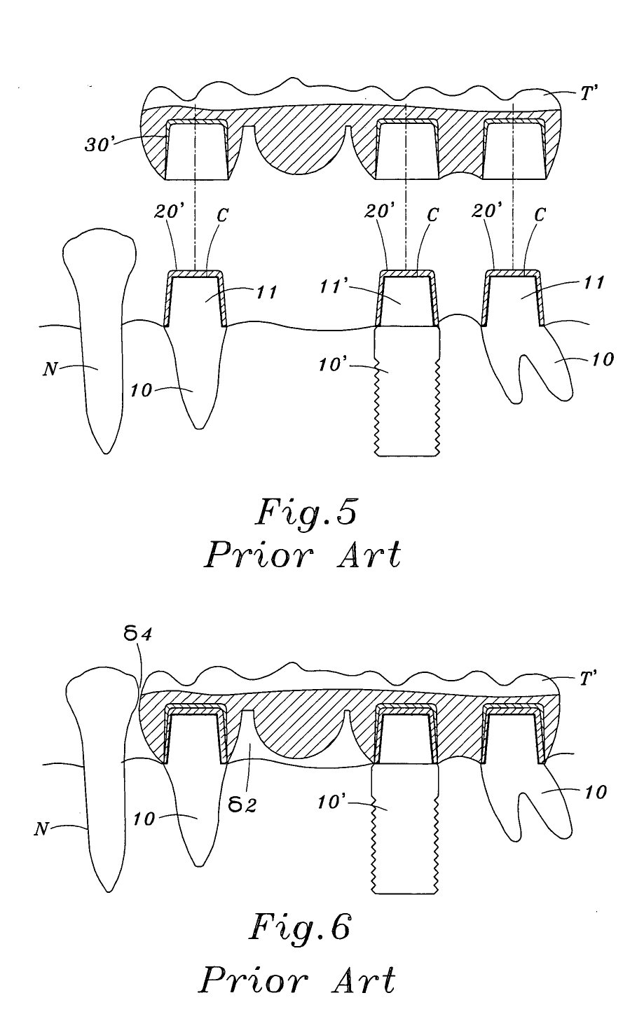

### DETAILED DESCRIPTION OF THE PREFERRED EMBODIMENT

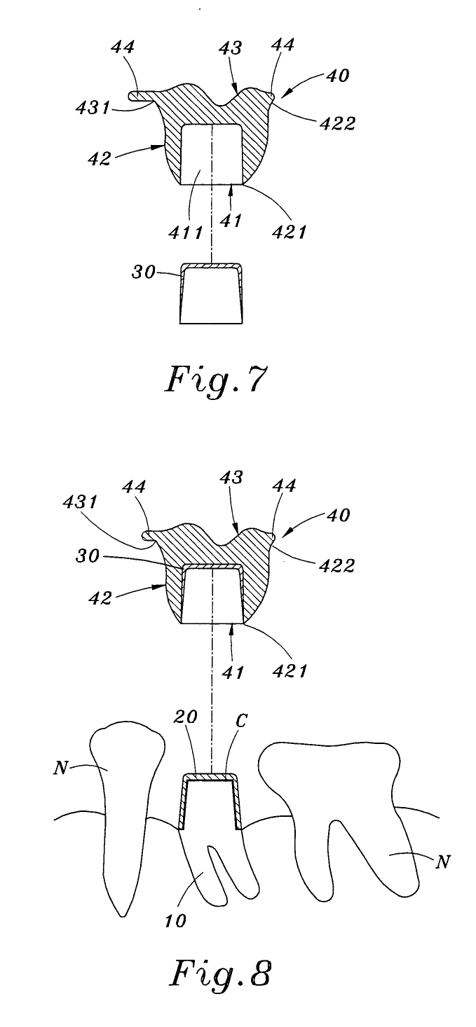

As shown in FIG. 7 to FIG. 9, a detachable restoration tooth 40 embodied in the present invention has a bottom 41, an outside surface 42, and a top 43. The bottom 41 is provided with a cavity 411 extending into the interior of the restoration tooth 40. The cavity 411 is used to accommodate an outer crown 30. The open end of the cavity 411 and the outer surface 42 have a boundary edge 421. The top 43 and the outer surface 42 have a boundary edge 422 and a boundary edge 431. Two connection portions 44 are formed by the top 43 and the two boundary edges 422 and 431.

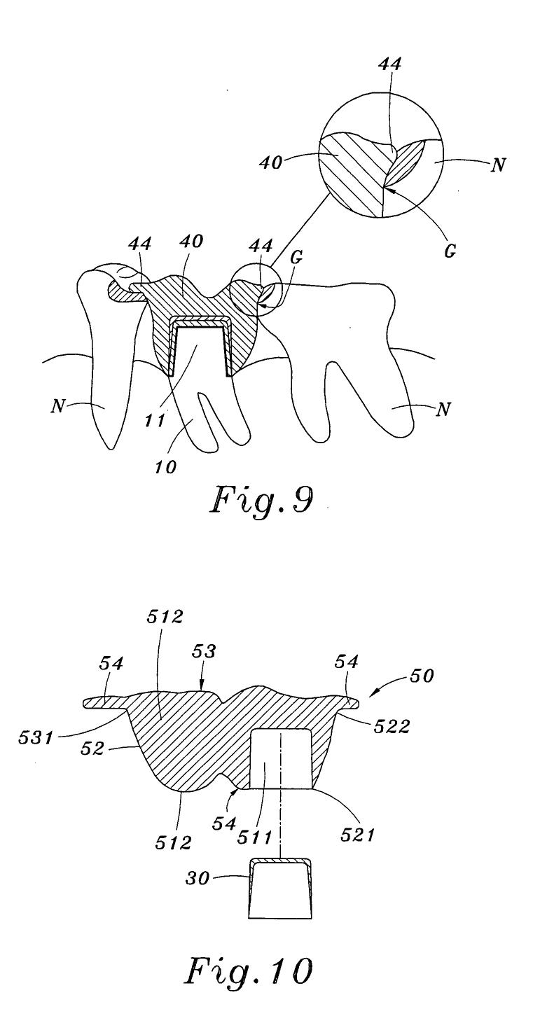

As shown in FIGS. 8 and 9, the restoration tooth 40 of the present invention is used to restore a decayed ore diseased tooth 10 which is provided on the crown body thereof with an abutment seat 11 and a inner crown 20 fitted over the abutment seat 11. The restoration tooth 40 is removably mounted on the abutment seat 11 of the tooth 10 such that the outer crown 30 of the restoration tooth 40 is fitted over the inner crown 20 of the tooth 10 in conjunction with a cement “C”, with the two connection portions 44 of the restoration tooth 40 being respectively attached to the top of two healthy teeth “N” adjoining the tooth 10 to be restored. These two healthy teeth “N” are not subjected to grinding and mending. In addition, the connection portions 44 and the healthy teeth “N” have an intimate contact line “G” serving to avert the formation of a gap. The connection portions 44 also serve to distribute the chewing pressure to the adjoining healthy teeth “N”, so as to alleviate the chewing burden of the restoration tooth 40. As a result, the longevity of the restoration tooth 40 is effectively prolonged.

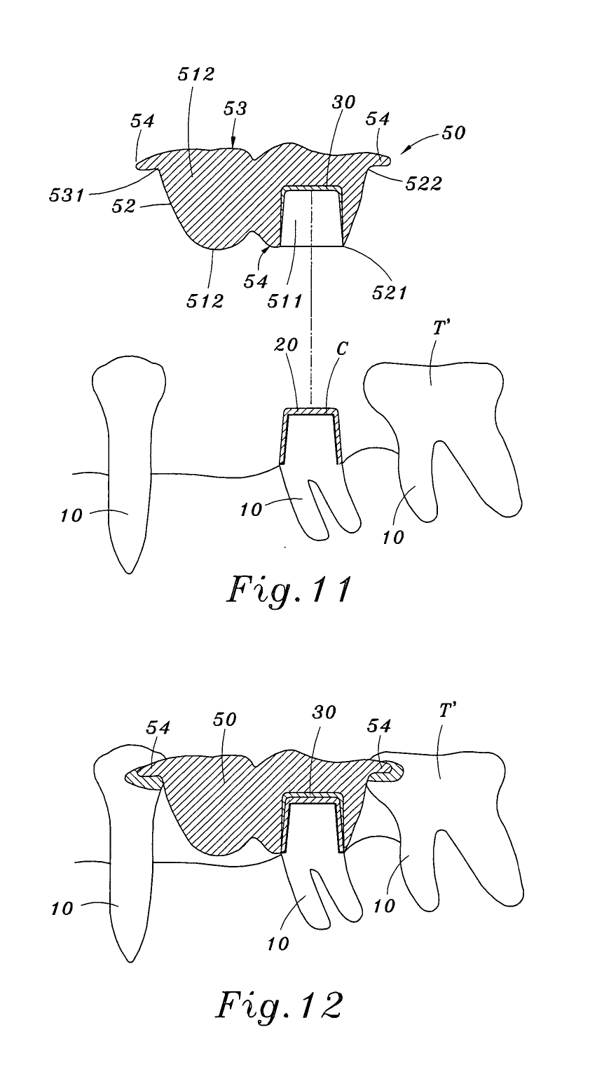

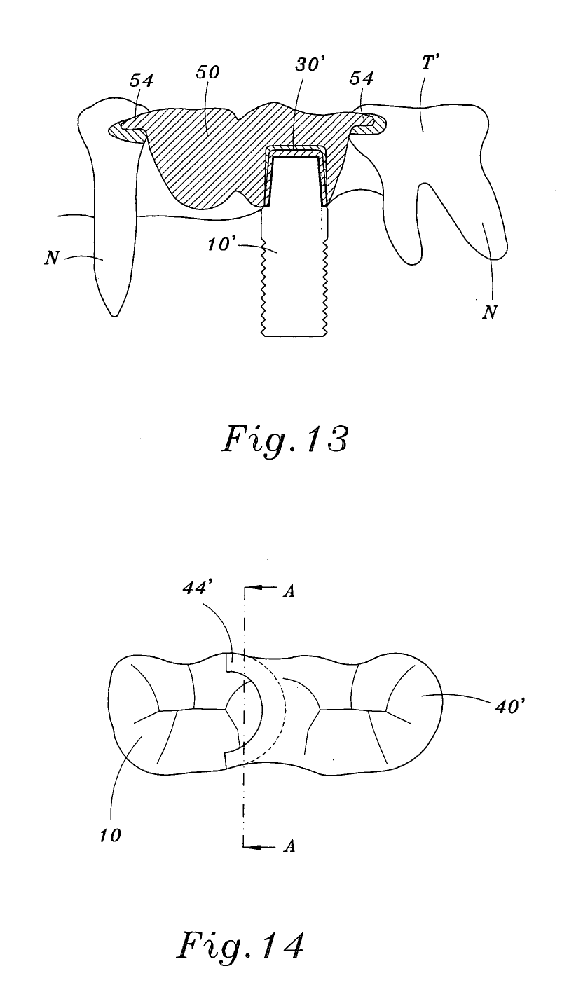

As shown in FIGS. 10-13, a detachable restoration tooth 50 embodied in the present invention has a bottom 51, an outer surface 52, and a top 53. The top 53 and the outer surface 52 have two boundary edges 522 and 531, from which two connection portions 54 are formed. The bottom 51 is provided in one side with a cavity 511 extending into an interior of the restoration tooth 50. The cavity 511 is intended to accommodate an outer crown 30. The bottom 51 is provided in other side with a protruded portion 512. The open end of the cavity 511 and the outer surface 52 have a boundary edge 521. As shown in FIGS. 11 and 12, a decayed or diseased tooth 10 is to be restored and is provided with an inner crown 20 fitted over the crown body thereof. The restoration tooth 50 is mounted on the decayed or diseased tooth 10 such that the outer crown 30 of the restoration tooth 50 is fitted over the inner crown 20 of the decayed or diseased tooth 10 in conjunction with a cement “C”, and that the connection portions 54 of the restoration tooth 50 are attached to two health teeth “N” adjoining the decayed or diseased tooth 10. The protruded portion 512 of the bottom 51 of the restoration tooth 50 fills in the gap between the restored tooth 10 and one of the two healthy teeth “N” adjoining the restored tooth 10.

As shown in FIG. 13, the restoration tooth 50 of the present invention is mounted on an artificial abutment tooth 10′ in place of the restored tooth 10.

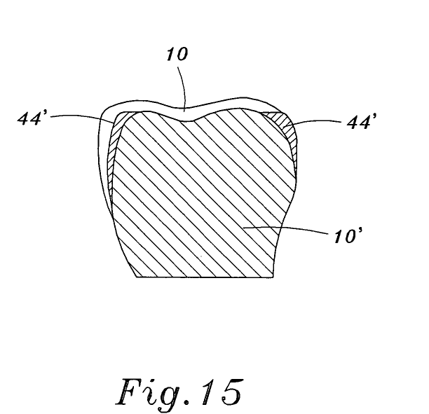

As shown in FIGS. 14 and 15, a detachable restoration tooth 40′ embodied in the present invention is provided with a lateral connection portion 44′ extending from a connection portion thereof. The lateral connection portion 44′ is intended to connect laterally the restoration tooth 40′ with one of the two healthy teeth “N” adjoining the restoration tooth 40′.

It is readily apparent that the restoration teeth of the present invention overcome the deficiencies of the prior art restoration teeth. In the first place, the service life span of the present invention is prolonged without subjecting any healthy tooth to grinding and mending. The connection portions of the restoration teeth of the present invention serve to soothe the act of chewing and to prevent food from being caught in the gap between the restored tooth and the healthy tooth adjacent to the restored tooth.

The embodiments of the present invention described above are merely illustrative. Accordingly, the present invention may be embodied in other specific forms without deviating from the spirit thereof. The present invention is therefore to be limited only by the scopes of the following claims.

1. A detachable restoration tooth, comprising:
a bottom provided with a cavity extending into the interior of said detachable restoration tooth and to accommodate an outer crown:
an outer surface having a boundary edge in relation to said bottom; and
a top having two boundary edges in relation to the outer surface whereby said top is provided with two connection portions, and each extending from one of said two boundary edges.

2. A detachable restoration tooth, as recited in claim 1, wherein said two connection portions of the top are attached to the top of two healthy teeth adjoining a restored tooth.

3. A detachable restoration tooth, as recited in claim 1, wherein said connection portions are attached to a projection of the side of two healthy teeth adjoining a restored tooth.

4. A detachable restoration tooth, as recited in claim 1, wherein said connection portions are provided with a lateral connection portion.

5. A detachable restoration tooth, comprising:
a bottom provided in one side thereof with a cavity extending into the interior of said detachable restoration tooth and to accommodate an outer crown, and in other side thereof with a protruded portion;
an outer surface having a boundary edge in relation to said bottom; and
a top having two boundary edges in relation to the outer surface whereby said top is provided with two connection portions, and each extending from one of said two boundary edges.

6. A detachable restoration tooth, as recited in claim 5, wherein said two connection portions of the top are attached to the top of two healthy teeth adjoining a restored tooth.

7. A detachable restoration tooth, as recited in claim 5, wherein said connection portions are attached to a projection of the side of two healthy teeth adjoining a restored tooth.

8. A detachable restoration tooth, as recited in claim 5, wherein said connection portions are provided with a lateral connection portion.
